(19) United States
(12) Patent Application Publication
(10) Pub. No.: US 2025/0232358 A1
(43) Pub. Date: Jul. 17, 2025

(54) DUPLICATE PURCHASE ALERT IN AN ELECTRONIC DEVICE

(71) Applicant: MOTOROLA MOBILITY LLC, WILMINGTON, DE (US)

(72) Inventors: AMIT KUMAR AGRAWAL, BANGALORE (IN); SHUAIB PUZHAKKAL KAVALATHARA, TIRUR (IN); NAGAVALI JATAVALLABHULA, BANGALORE (IN); PANDURANGA REDDY PAILLA, NALGONDA (IN)

(21) Appl. No.: 18/414,503

(22) Filed: Jan. 17, 2024

(51) Int. Cl. G06Q 30/0601

(52) U.S. Cl. CPC G06Q 30/0633; G06Q 30/0641

(57) ABSTRACT

An electronic device, a method and a computer program product for tracking personal and collaborative purchasing. The method includes detecting a trigger indicative of an intended purchase of a first item. In response to detecting the trigger, the method includes transmitting a request for collaborative shopping data with a previously purchased second item. In response to receiving the collaborative shopping data with the previously purchased second item, the method includes determining whether the first item is substantially similar to the previously purchased second item. In response to the first item being substantially similar to the previously purchased second item, the method includes identifying the intended purchase of the first item as a potential duplicate purchase and presenting a duplicate purchase alert on a display. The duplicate purchase alert indicates that completion of the intended purchase of the first item will potentially result in a duplicate purchase.

### RELATED APPLICATIONS

This application is related to U.S. application Ser. No. ______, filed concurrently herewith, the contents of which are incorporated herein by reference.

### BACKGROUND

### 1. Technical Field

The present disclosure generally relates to electronic devices and in particular to using electronic devices to facilitate online shopping and transactions.

### 2. Description of the Related Art

Electronic devices, such as mobile phones, tablets, and laptops, are widely used for video, voice, and text communication and for data transmission. Online shopping has also become a popular use for these mobile electronic devices. Online shopping is a form of electronic commerce that allows consumers to purchase goods or services using an electronic device. Consumers can find a product of interest by visiting retailer websites or by using a search engine that displays the availability and price of a product at different merchants. The consumer can then complete the purchase of the product using their electronic device.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example electronic device within which various aspects of the disclosure can be implemented, according to one or more embodiments;

FIG. 2 is an example illustration of the electronic device of FIG. 1 transmitting a request for collaborative shopping data to an application computer system and a receiving a response from the application computer system, according to one or more embodiments;

FIGS. 3A and 3B are block diagrams of example contents of the system memory of the example electronic device of FIG. 1 configured to complete the various processes described herein, according to one or more embodiments;

FIG. 4A is an example illustration of a display of an electronic device presenting a graphical user interface (GUI) that includes an option to establish a collaborative shopping group, according to one or more embodiments;

FIG. 4B is an example illustration of a display of an electronic device presenting a GUI to select one or more members of a collaborative shopping group, according to one or more embodiments;

FIG. 4C is an example illustration of a display of an electronic device presenting a GUI to select one or more items to include in a list of items that are to be purchased by members of a collaborative shopping group, according to one or more embodiments;

FIG. 5A is an example illustration of a display of an electronic device presenting a GUI that includes a location-based duplicate purchase alert, according to one or more embodiments;

FIG. 5B is an example illustration of a display of an electronic device presenting a GUI after a shopping application has been initiated and including a duplicate purchase alert that another member of a collaborative shopping group has recently purchased an item having a common merchandise category, according to one or more embodiments;

FIG. 6A is an example illustration of a display of an electronic device presenting a GUI that includes an example shopping page to purchase at least one item, according to one or more embodiments;

FIG. 6B is an example illustration of a display of an electronic device presenting a GUI after an item has been added to a shopping cart and including a duplicate purchase alert that another member of a collaborative shopping group has recently purchased an item having a common merchandise category, according to one or more embodiments;

FIG. 7A is an example illustration of a display of an electronic device presenting a GUI to select one or more merchandise categories and types associated with the purchase of at least one item to be designated as private purchase categories and types, according to one or more embodiments;

FIG. 7B is an example illustration of a display of an electronic device presenting a GUI that includes a private purchase alert that a purchase transaction involving at least one item has been tagged as a confidential purchase transaction.

FIG. 8 depicts a flowchart of a method by which an electronic device tracks personal and collaborative purchasing to identify and generate a notification about a potential duplicate purchase of at least one item, according to one or more embodiments;

FIG. 9 depicts a flowchart of a method by which an electronic device updates a collaborative shopping database in response to identifying that an incoming communication contains information corresponding to the purchase of the at least one item, according to one or more embodiments; and

FIG. 10 depicts a flowchart of a method by which an electronic device tracks personal and collaborative purchasing of at least one item to identify if an item that is being purchased is a private purchase transaction, according to one or more embodiments.

### DETAILED DESCRIPTION

According to one or more aspects of the disclosure, the illustrative embodiments provide an electronic device, a method, and a computer program product for tracking collaborative purchasing to identify and generate a notification about a potential duplicate purchase of at least one item. In a first embodiment, an electronic device includes a display, a communication system that enables the electronic device to connect to external networks and devices, and a memory having stored thereon a duplicate purchase alert (DPA) module for tracking personal and collaborative purchasing to identify and generate notification about a potential duplicate purchase of at least one item. The electronic device includes at least one processor that is communicatively coupled to the display, the communication system, and the memory. The at least one processor executes program code of the duplicate purchase alert module, which configures the electronic device to detect a trigger indicative of an intended purchase of a first item. In response to detecting the trigger, the at least one processor transmits, to a purchase tracking repository, a request for collaborative shopping data with at least one previously purchased second item. In response to receiving the collaborative shopping data with the at least one previously purchased second item, the at least one processor determines whether the first item is substantially similar to the at least one previously purchased second item. In response to the first item being substantially similar to the at least one previously purchased second item, the at least one processor identifies the intended purchase of the first item as a potential duplicate purchase and presents a duplicate purchase alert on the display. The duplicate purchase alert indicates that completion of the intended purchase of the first item will potentially result in a duplicate purchase.

According to another embodiment, the method includes detecting, via at least one processor, a trigger indicative of an intended purchase of a first item. In response to detecting the trigger, the method includes transmitting, to a purchase tracking repository, a request for collaborative shopping data with at least one previously purchased second item. In response to receiving the collaborative shopping data with the at least one previously purchased second item, the method includes determining whether the first item is substantially similar to the at least one previously purchased second item. In response to the first item being substantially similar to the at least one previously purchased second item, the method includes identifying the intended purchase of the first item as a potential duplicate purchase and presenting a duplicate purchase alert on a display. The duplicate purchase alert indicates that completion of the intended purchase of the first item will potentially result in a duplicate purchase.

According to another aspect of the disclosure, the illustrative embodiments provide an electronic device, a method, and a computer program product for tracking and separating personal from collaborative purchasing of at least one item. In one or more embodiments, an electronic device includes a display, a communication system that enables the electronic device to connect to external networks and devices, and a memory having stored thereon a purchase tracking and alert (PTA) module a memory having stored thereon a purchase tracking and alert (PTA) module for tracking and separating personal and collaborative purchasing of at least one item. The electronic device includes at least one processor that is communicatively coupled to the display, the communication system, and the memory. The at least one processor executes program code of the purchase tracking and alert module, which configures the electronic device to detect a trigger indicative of an intended purchase of a first item. In response to detecting the trigger, the at least one processor identifies a first merchandise category and type associated with the first item. The at least one processor determines if the first merchandise category and type corresponds to a purchase transaction that is to be maintained as a private purchase transaction. In response to determining that the first merchandise category and type is a private purchase transaction, the at least one processor tags the purchase involving the first item as a confidential purchase transaction that is not to be shared with others within a collaborative shopping group and withholds transmission of a notification of the intended purchase of the first item to a collaborative shopping database.

According to one more embodiment, the method includes retrieving private purchase data from a memory. The private purchase data comprises at least one merchandise category and type for which associated purchases have been designated as private purchases that are not to be shared to a collaborative shopping database. The method includes comparing the identifying data of the first item with the private purchase data and in response to the identifying data of the first item being substantially similar to the private purchase data, tagging a purchase transaction involving the first item as a confidential purchase transaction that is not to be shared with others within a collaborative shopping group.

According to an additional embodiment, the method includes detecting, via at least one processor of an electronic device, a trigger indicative of an intended purchase of a first item. In response to detecting the trigger, the method includes identifying a first merchandise category and type associated with the first item and determining if the first merchandise category and type corresponds to a purchase transaction that is to be maintained as a private purchase transaction. In response to determining that the first merchandise category and type is a private purchase transaction, the method includes withholding transmission of a notification of the intended purchase of the first item to a collaborative shopping database.

According to additional embodiments, respective computer program products include a computer readable storage device having stored thereon program code that, when executed by at least one processor of an electronic device having a display and a communication system, the program code enables the electronic device to complete the functionality of the particular one of the above-described method processes.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

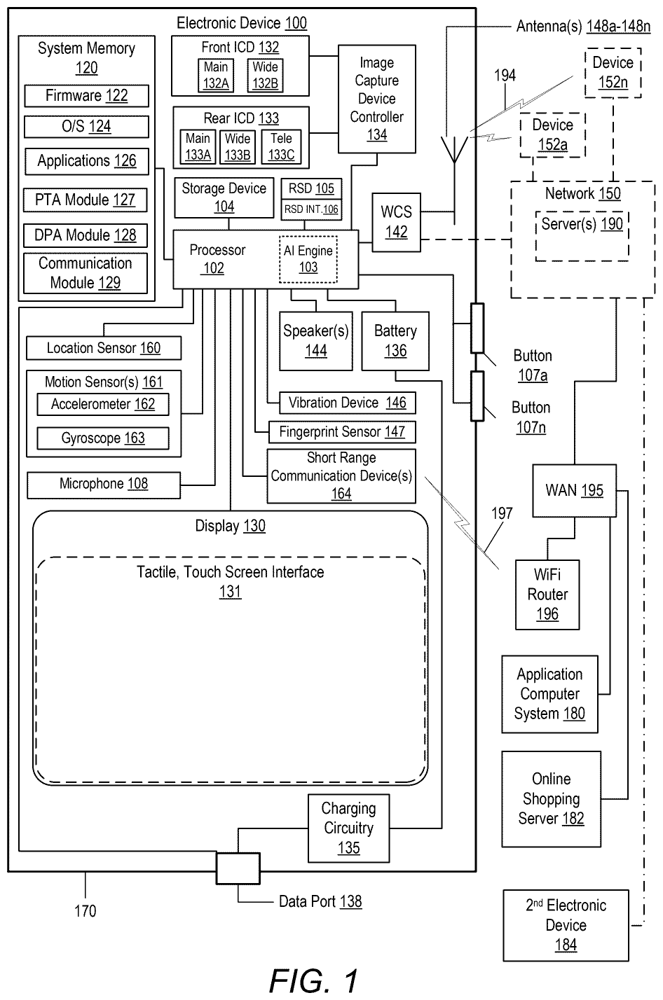

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

FIG. 1 depicts an example electronic device 100 within which various aspects of the disclosure can be implemented, according to one or more embodiments. Examples of such electronic devices include, but are not limited to, mobile devices, a notebook computer, a mobile phone, a digital camera, a smart watch, a tablet computer, and a communication device, etc. It is appreciated that electronic device 100 can be other types of devices that include the capability to transmit and receive communications. Electronic device 100 includes processor 102, which is communicatively coupled to storage device 104, system memory 120, input devices, (introduced below), output devices, such as display 130, and image capture device (ICD) controller 134. In one or more embodiments, the functionality of ICD controller 134 is incorporated within processor 102, eliminating the need for a separate ICD controller. For simplicity in describing the features presented herein, the various camera control functions performed by the ICD controller 134 are described as being provided generally by processor 102. Processor 102 can include processor resources such as a primary processing unit (CPU) that support computing, classifying, processing and transmitting of data and information. Processor 102 can further include graphic processing units (GPU) and digital signal processors (DSP) that also support computing, classifying, processing and transmitting and receiving of data and information. Processor 102 can further include a hardware based artificial intelligence (AI) engine 103. AI engine 103 accelerates artificial intelligence, natural language processing (NLP), context evaluation (CE), and machine learning applications. AI engine 103 can also be implemented as a software module, in one embodiment.

System memory 120 may be a combination of volatile and non-volatile memory, such as random access memory (RAM) and read-only memory (ROM). System memory 120 can store program code and data associated with firmware 122, an operating system 124, applications 126, purchase tracking and alert (PTA) module 127, duplicate purchase alert (DPA) module 128, and communication module 129. Purchase tracking and alert module 127 includes program code that is executable by processor 102 to enable electronic device 100 to track personal and collaborative purchases to identify private purchase items that are not to be shared to a collaborative shopping database. Duplicate purchase alert module 128 includes program code that is executable by processor 102 to enable electronic device 100 to track personal and collaborative purchases to identify and generate a notification about a potential duplicate purchase of at least one item. Communication module 129 includes program code that is executed by processor 102 to enable electronic device 100 to communicate with other external devices and systems.

Although depicted as being separate from applications 126, purchase tracking and alert module 127, duplicate purchase alert module 128, and communication module 129 may each be implemented as an application. Processor 102 loads and executes program code stored in system memory 120, including program code associated with applications 126 and program code associated with purchase tracking and alert module 127, duplicate purchase alert module 128, and communication module 129. When processed/executed by processor 102, the program code causes or configures electronic device 100 to provide the various functionality described herein.

In one or more embodiments, electronic device includes removable storage device (RSD) 105, which is inserted into an RSD interface 106 that is communicatively coupled via system interlink to processor 102. In one or more embodiments, RSD 105 is a non-transitory computer program product or computer readable storage device. In one or more embodiments, RSD 105 is a computer readable storage device encoded with program code and corresponding data, and RSD 105 can interchangeably be referred to as a non-transitory computer program product. RSD 105 may have a version of purchase tracking and alert module 127 and duplicate purchase alert module 128 stored thereon, in addition to other program code. Processor 102 can access RSD 105 to provision electronic device 100 with program code that, when executed by processor 102, the program code causes or configures electronic device 100 to provide the functionality described herein.

Display 130 can be one of a wide variety of display screens or devices, such as a liquid crystal display (LCD) and an organic light emitting diode (OLED) display. In some embodiments, display 130 can be a touch screen device that can receive user tactile/touch input. As a touch screen device, display 130 includes a tactile, touch screen interface 131 that allows a user to provide input to or to control electronic device 100 by touching features presented within/below the display screen. Tactile, touch screen interface 131 can be utilized as an input device.

Throughout the disclosure, the term image capturing device is utilized interchangeably to be synonymous with and/or refer to any one of front or rear cameras 132, 133. As illustrated, electronic device 100 includes several front cameras 132. Electronic device 100 further includes several rear cameras 133. Each front camera 132A and 132B and each rear camera 133A, 133B and 133C is communicatively coupled to ICD controller 134, which is communicatively coupled to processor 102. ICD controller 134 supports the processing of signals from front cameras 132A and 132B and rear cameras 133A, 133B, and 133C.

Electronic device 100 can further include charging circuitry 135, battery 136, and data port 138, for providing electrical power to the various electronic components of electronic device 100. Electronic device 100 further includes microphone 108, one or more output devices such as speaker 144, and one or more input buttons 107a-n. Input buttons 107a-n may provide controls for volume, power, and/or image capture devices 132, 133. Microphone 108 can also be referred to as audio input device 108. Microphone 108 can be used to provide biometric data to identify or authenticate a user. Microphone 108 and input buttons 107a-n can also be referred to generally as input devices. Speaker 144 can provide an audio alert to a user.

Electronic device 100 further includes wireless communication subsystem (WCS) 142, which is coupled to antennas 148a-148n. In one or more embodiments, WCS 142 can include a communication module with one or more baseband processors or digital signal processors, one or more modems, and a radio frequency front end having one or more transmitters and one or more receivers. Wireless communication subsystem (WCS) 142 and antennas 148a-148n allow electronic device 100 to communicate wirelessly with wireless network 150 via transmissions of communication signals 194 to and from network communication devices 152a-152n, such as base stations or cellular nodes, of wireless network 150.

In one or more embodiment, wireless network 150 can include one or more servers 190 that support wireless exchange of voice, data, and video and other communication with electronic device 100. Wireless network 150 further allows electronic device 100 to communicate with application computer system 180, online shopping server 182, and second electronic device 184. Application computer system 180 and online shopping server 182 are communicatively coupled to wireless network 150 by a wide area network (WAN) 195, such as the Internet. In an embodiment, servers 190 of wireless network 150 support wireless exchange of e-mail, text, data, and other communications between electronic device 100 and application computer system 180 and online shopping server 182. In one embodiment, application computer system 180 and online shopping server 182 can provide data, information, and resources to electronic device 100 for use with applications 126, purchase tracking and alert module 127, and duplicate purchase alert module 128.

Second electronic device 184 is also communicatively coupled to wireless network 150. Second electronic device 184 can be similarly connected to wireless network 150, via one of network communication devices 152a-152n. In an embodiment, servers 190 of wireless network 150 support wireless exchange of voice, text, data, and video and other communication between electronic device 100 and second electronic device 184.

Electronic device 100 further includes short range communication device(s) 164. Short-range communication device 164 is a low powered transceiver that can wirelessly communicate with other devices. Short-range communication device(s) 164 can include one or more of a variety of devices supporting different corresponding wireless protocols, such as a near field communication (NFC) device, a Bluetooth device, and/or a wireless fidelity (Wi-Fi) device. Electronic device 100 can also connect wirelessly to wireless network 150 via communication signals 197 transmitted by short-range communication device(s) 164 to and from WiFi router 196, which is communicatively coupled to WAN 195, such as the Internet. Wireless network 150 is communicatively coupled to WAN 195.

Short-range communication device(s) 164 can wirelessly communicate with WiFi router 196 via communication signals 197. In one embodiment, electronic device 100 can receive Internet or Wi-Fi based calls via short-range communication device(s) 164. In one embodiment, electronic device 100 can communicate with WiFi router 196 wirelessly via short-range communication device(s) 164. In an embodiment, WCS 142, antennas 148a-148n and short-range communication device(s) 164 collectively provide communication interface(s) of electronic device 100.

Electronic device 100 further includes vibration device 146, fingerprint sensor 147, location sensor 160, and motion sensor(s) 161. Vibration device 146 can cause electronic device 100 to vibrate or shake when activated. Vibration device 146 can be activated to provide an alert or notification to a user of electronic device 100. According to one aspect of the disclosure, display 130, speakers 144, and vibration device 146 can generally and collectively be referred to as output devices. These output devices can be each utilized to present the different alerts to the user.

Fingerprint sensor 147 can be used to provide biometric data or images to identify or authenticate a user. Location sensor 160 can provide time data and location data about the physical location of electronic device 100. In one embodiment, location sensor 160 can be a global positioning system (GPS) device that uses data received from geospatial input received from GPS satellites. Location information and data received from location sensor 160 can be utilized to identify when an electronic device is at a store or merchant location where an intended purchase will likely occur of an item that is to be shared as a collaborative purchase with other members of a collaborative shopping group. In one embodiment, identifying that the electronic device is at a store or merchant location where the intended purchase of an item can occur is established as one trigger indicative of an intended purchase of a collaborative purchase item.

Motion sensor(s) 161 can include one or more accelerometers 162 and gyroscope 163. Motion sensor(s) 161 can detect movement of electronic device 100 and provide motion data to processor 102 indicating the spatial orientation and movement of electronic device 100. Accelerometers 162 measure linear acceleration of movement of electronic device 100 in multiple axes (X, Y and Z). For example, accelerometers 162 can include three accelerometers, where one accelerometer measures linear acceleration in the X axis, one accelerometer measures linear acceleration in the Y axis, and one accelerometer measures linear acceleration in the Z axis. Gyroscope 163 measures rotation or angular rotational velocity of electronic device 100. Electronic device 100 further includes a housing 170 that contains the components of electronic device 100.

In the description of each of the following figures, reference is also made to specific components illustrated within the preceding figure(s). Similar or same components are presented with the same leading reference number.

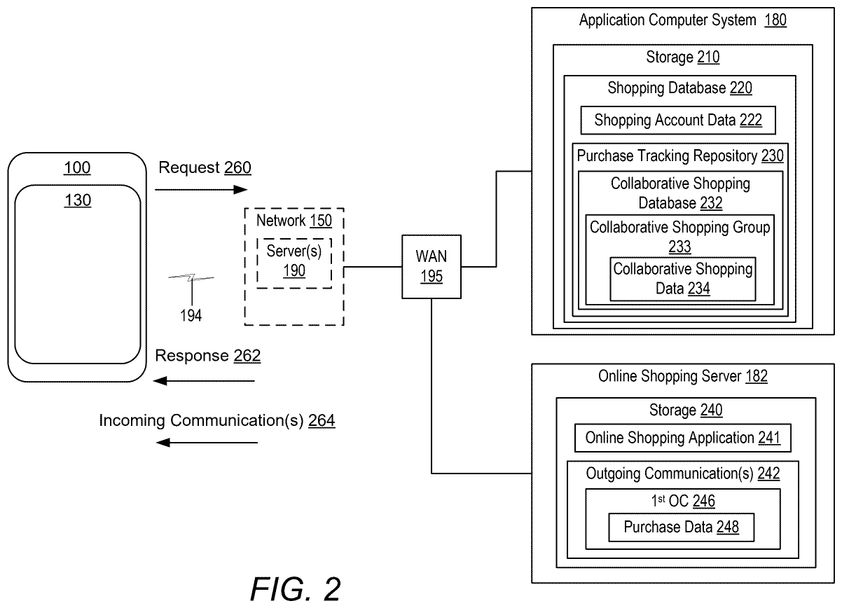

Turning to FIG. 2, with ongoing reference to FIG. 1, electronic device 100 is shown in communication with application computer system 180 and online shopping server 182. Electronic device 100 can communicate wirelessly with wireless network 150 via transmission and reception of communication signals 194. Communication network 150 includes communication servers 190 that are communicatively connected to a larger, wide area network

(WAN) 195, such as the Internet. Electronic device 100 can also establish connection and communicate with wireless network 150 and with WAN 195 via WiFi router 196 and short-range communication device(s) 164 (FIG. 1).

Application computer system 180 and online shopping server 182 are communicatively coupled to a wide area network (WAN) 195, such as the Internet, to which server 190 of wireless network 150 is also communicatively coupled. In an embodiment, servers 190 of wireless network 150 support wireless exchange of e-mail, text, data, and other communication between electronic device 100 and application computer system 180 and online shopping server 182

Application computer system 180 can host one or more applications that provide various functions. In an example embodiment, application computer system 180 can host shopping applications, banking applications, and web browser applications. Application computer system 180 includes storage 210, such as one or more hard drives or solid state drives. Storage 210 can store shopping database 220. Shopping database 220 can support one or more applications 126 of electronic device 100.

Shopping database 220 includes shopping account data 222 and purchase tracking repository 230. Purchase tracking repository 230 includes a collaborative shopping database 232, which stores collaborative shopping data 234 of collaborative shopping group 233. Shopping account data 222 can include user account data, merchant information, preferred payment methods, and preferred shipping/delivery methods. Collaborative shopping data 234 can include information about items previously purchased or items that are in the process of being purchased by members of a pre-determined group of individuals, collaborative shopping group 233. In one embodiment, the pre-determined group of individuals can be family members. In another embodiment, the pre-determined group of individuals can be employees of a business. In one or more embodiments, the user of electronic device 100 can be affiliated with a plurality of collaborative shopping group(s) 233 that each maintains separate collaborative shopping data 234. Collaborative shopping data 234 contains data and information that is shared and/or utilized by members of the group. In one embodiment, collaborative shopping data 234 can be updated with purchase notifications or purchase intentions from various sources, including information about the actual item purchased, the shopping category associated with the item, and the date/time of the purchase.

According to one aspect of the disclosure, electronic device 100 can transmit a request 260 to application computer system 180 for collaborative shopping data 234 with at least one previously purchased item. In one or more embodiments, a purchase transaction can be completed via online shopping server 182 that is communicatively connected to WAN 195. In yet another embodiment, an intended purchase transaction can be determined when an item is placed in a shopping cart of the online shopping server 182. The purchase transaction and/or intended purchase transaction triggers the electronic device 100 to transmit request 260. Other triggers are possible, including detection of entry by electronic device 100 into a location of a shopping establishment or log on to a shopping website/portal, such as provided by online shopping server 182. Electronic device 100 can receive, in response to the request 260, a response 262 that contains the collaborative shopping data 234 with at least one previously purchased item. Electronic device 100 and application computer system 180 can perform a validation and authentication routine prior to the exchange of data and information to provide account verification and security for access by electronic device to a specific one or more collaborative shopping data 234 of an affiliated one or more collaborative shopping group 233.

Online shopping server 182 can host one or more third party shopping applications 241 that provide access to goods and services. Online shopping server 182 includes storage 240, such as one or more hard drives or solid state drives. Storage 240 can store online shopping application 241 and outgoing communications 242, including a first outgoing communication (OC) 246. In one embodiment, first outgoing communication 246 can be at least one of an e-mail, text, data, and other communication types. First outgoing communication 246 includes purchase data 248. Purchase data 248 includes information about actual items purchased, the shopping category associated with the item and the date/time of the purchase. In one embodiment, when a user of electronic device 100 purchases an item via online shopping application 241 of online shopping server 182, the online shopping server can send first outgoing communication 246 (e.g., an e-mail) to electronic device 100 including the purchase data 248 about the purchase.

According to one aspect of the disclosure, electronic device 100 can monitor for and receive incoming communications 264 that correspond to the outgoing communications 242 sent by online shopping server 182.

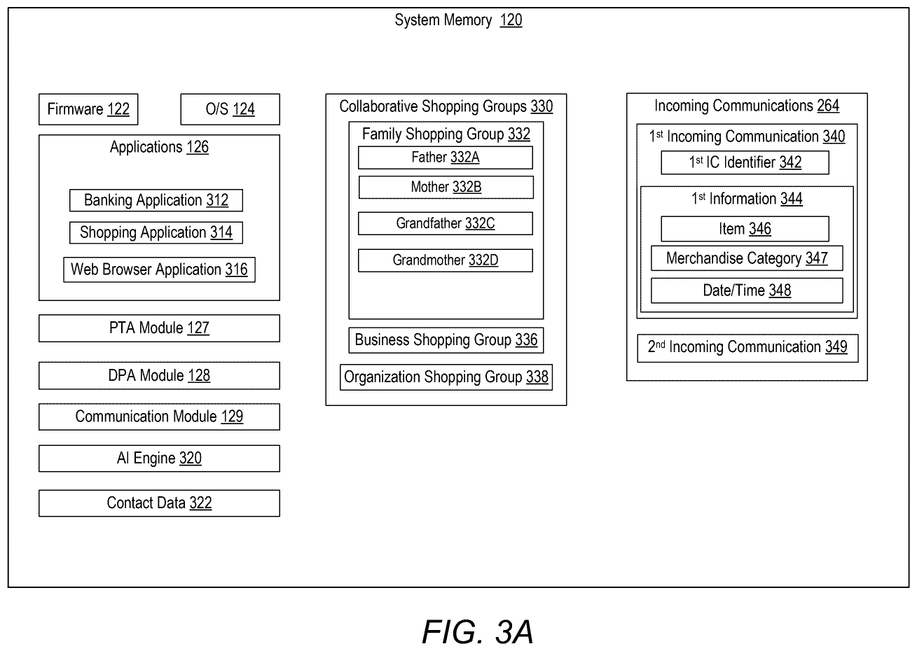

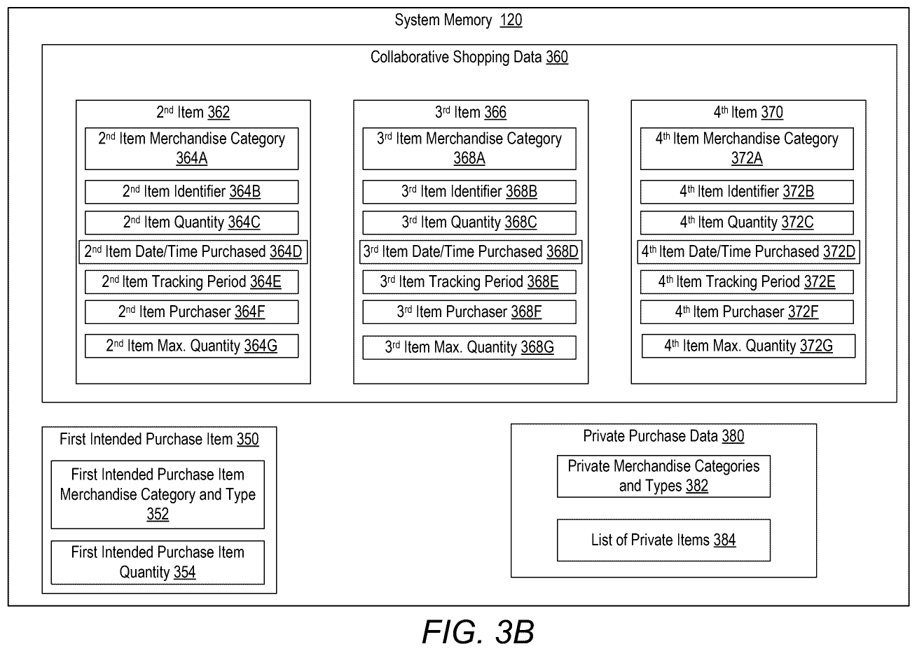

Referring to FIG. 3A, there is shown one embodiment of example contents of system memory 120 of electronic device 100 configured to complete the various processes described herein. System memory 120 includes data, software, and/or firmware modules, including firmware 122, an operating system (O/S) 124, applications 126, purchase tracking and alert module 127, duplicate purchase alert module 128, and communication module 129.

Applications 126 include banking application 312, shopping application 314, and web browser application 316. Banking application 312 includes program code that is executed by processor 102 to enable electronic device 100 to access banking services provided by a bank or other financial institution, such as a credit card company, online payment service, etc. Shopping application 314 includes program code that is executed by processor 102 to enable electronic device 100 to access websites to browse and buy products or services from a retailer or service provider. Web browser application 316 includes program code that is executed by processor 102 to enable electronic device 100 to access various websites of the Internet. While applications 126 are shown including three applications, applications 126 can include more or fewer than three applications.

Purchase tracking and alert module 127 and duplicate purchase alert module 128 each includes program code that is executed by processor 102 to enable electronic device 100 to perform the various features of the present disclosure. In one or more embodiments, purchase tracking and alert module 127 enables electronic device 100 to identify at least one item as a private purchase transaction and prevent transmitting notification of the intended (or completed) purchase of the at least one item to a collaborative shopping database. Duplicate purchase alert module 128 enables electronic device 100 to track personal and collaborative purchases to identify and generate a notification about a potential duplicate purchase of at least one item.

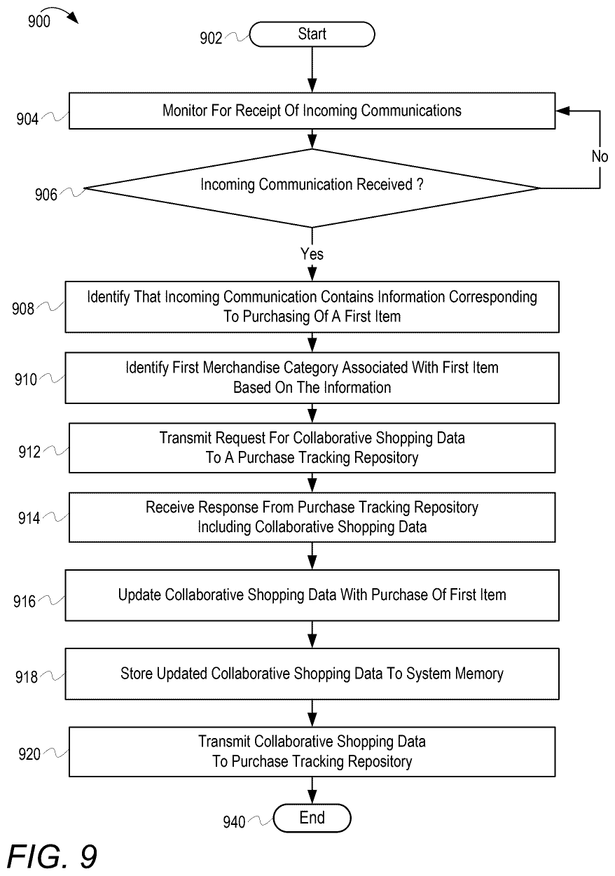

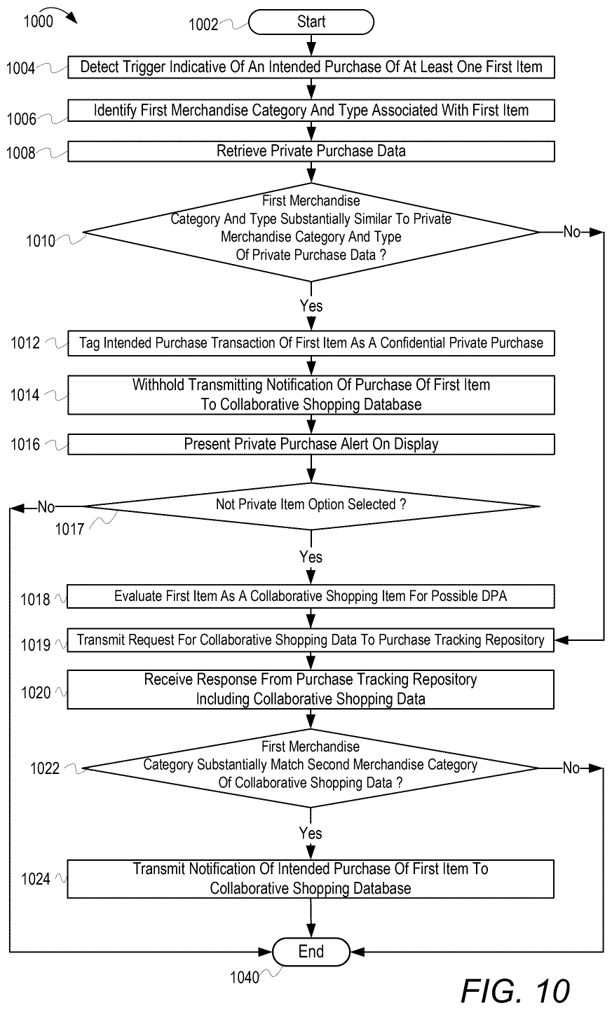

In one or more embodiments, execution of duplicate purchase alert module 128 by processor 102 configures electronic device 100 to perform the processes presented in the flowcharts of FIGS. 8 and 9, as will be described below. In one or more embodiments, execution of purchase tracking and alert module 127 by processor 102 configures electronic device 100 to perform the processes presented in the flowchart of FIG. 10, as will be described below. Communication module 129 enables electronic device 100 to communicate and exchange data with other devices via wireless network 150 and/or WiFi router 196.

System memory 120 includes artificial intelligence (AI) engine 320 and contact data 322. AI engine 320 accelerates artificial intelligence, natural language processing (NLP), context evaluation (CE), and machine learning applications. Contact data 322 is a directory or list of known family members, friends and workers including e-mail addresses, messaging addresses and phone numbers.

System memory 120 includes one or more collaborative shopping groups 330. Collaborative shopping groups 330 are pre-determined groups of members that purchase items that are used within a family or business. Example collaborative shopping groups 330 include family collaborative shopping group 332, business collaborative shopping group 336, and organization shopping group 338. While three collaborative shopping groups are shown, collaborative shopping group 330 can have more or less than three collaborative shopping groups. Family collaborative shopping group 332 can include several family members, such as father 332A, mother 332B, grandfather 332C, and grandmother 332D. In one embodiment, business collaborative shopping group 336 can include at least a portion of the employees of a business or company. An organization shopping group 338 can include persons affiliated with an organization, such as a school or charity, who may not be personally connected otherwise.

System memory 120 includes one or more incoming communications 264. Incoming communications 264 are received from online shopping server 182. In one embodiment, incoming communications 264 can be at least one of an e-mail, text, data, and other communication types. Incoming communications 264 include first incoming communication 340 and second incoming communication 349. First incoming communication 340 includes first incoming communication (IC) identifier 342 and first information 344. In one embodiment, electronic device 100 can identify that first information 344 contains information about a potential duplicate purchase of at least one item. First information 344 can include an identity of at least one item 346 that was purchased or is intended to be purchased, a merchandise category 347 associated with item 346, and a date/time 348 that the item 346 was purchased. In an example embodiment, first information 344 can indicate that a member of collaborative family shopping group 332 has recently purchased a loaf of bread from an online merchant. Second incoming communication 349 can include similar information as first incoming communication 340.

Turning to FIG. 3B, there is shown additional details of example contents of system memory 120 of electronic device 100 configured to complete the various processes described herein. System memory 120 includes first intended purchase item 350. First intended purchase item 350 is an item that corresponds to a pending transaction. In one embodiment, first intended purchase item 350 can be an item that has been added to a shopping cart of an online shopping application. First intended purchase item 350 includes a merchandise category and type 352 that identifies the product or merchandise category and type associated with the intended purchase item 350. First intended purchase item 350 further includes a first intended purchase item quantity 354 that corresponds to the number of items that have been selected for purchase or added to a shopping cart.

System memory 120 includes collaborative shopping data 360. Electronic device 100 can receive collaborative shopping data 360 from application computer system 180. Collaborative shopping data 360 contains data and information about previous purchases and intended purchases that are shared and/or utilized by members of a group of individuals such as family shopping group 332. In one embodiment, collaborative shopping data 360 can also be referred to as a collaborative shopping cart.

Collaborative shopping data 360 includes second item 362, third item 366, and fourth item 370. While three items are shown in collaborative shopping data 360, collaborative shopping data 360 can have more or less than three items. Second item 362 includes second item merchandise category 364A, second item name or identifier 364B, second item quantity 364C, second item date/time purchased 364D, second item tracking period 364E, second item purchaser 364F, and second item maximum quantity 364G.

Second item merchandise category 364A is the type of merchandise associated with the second item. In an example embodiment, if the second item is milk, the merchandise category can be dairy products. In another example embodiment, if the second item is bananas, the merchandise category can be fruit. Second item identifier 364B is the name of the second item. Second item quantity 364C is the number of the second items that have been purchased. Second item date/time purchased 364D is the date and time that the second item was purchased.

Second item tracking period 364E is a pre-established tracking period for preventing potential duplicative purchases. In one embodiment, second item tracking period 364E can at least partially be set based on the shelf life or expiration date of a perishable item. For example, if the second item is milk, second item tracking period 364E can be set to a ten day period. Second item purchaser 364F is the identity of the purchaser of second item 362. Second item maximum quantity 364G is the maximum number of second items that are desired to be purchased before a duplicate purchase alert is presented. In one example embodiment, if the second item is tomatoes, second item maximum quantity 364G can be set by a user to five pounds of tomatoes.

Third item 366 includes third item merchandise category 368A, third item name or identifier 368B, third item quantity 368C, third item date/time purchased 368D, third item tracking period 368E, third item purchaser 368F, and third item maximum quantity 368G. Similarly, fourth item 370 includes fourth item merchandise category 372A, fourth item name or identifier 372B, fourth item quantity 372C, fourth item date/time purchased 372D, fourth item tracking period 372E, fourth item purchaser 372F, and fourth item maximum quantity 372G.

System memory 120 includes private purchase data 380. Private purchase data 380 includes a list of private merchandise categories and types 382 and list of private items 384 that are considered private purchases by an individual. Private purchase data 380 includes items, that if purchased, a user of electronic device 100 would prefer that others not be aware of. Items that share a common merchandise categories and types with private merchandise categories and types 382 are not to be shared to collaborative shopping data 360 such that these items are not visible to other members of collaborative shopping groups 330. In an example embodiment, private purchase data 380 can include gift items, gift cards, medicines, medical supplies and personal hygiene products. List of private items 384 can be compiled by the device owner or identified based on user selection of an option to keep the purchase private during a purchase transaction. Alternatively, or in addition, list of private items can be determined the AI engine 320 tracking of purchases and performing a historical analysis of purchase data/patterns of the user using contextual information associated with the user and/or the historical purchases.

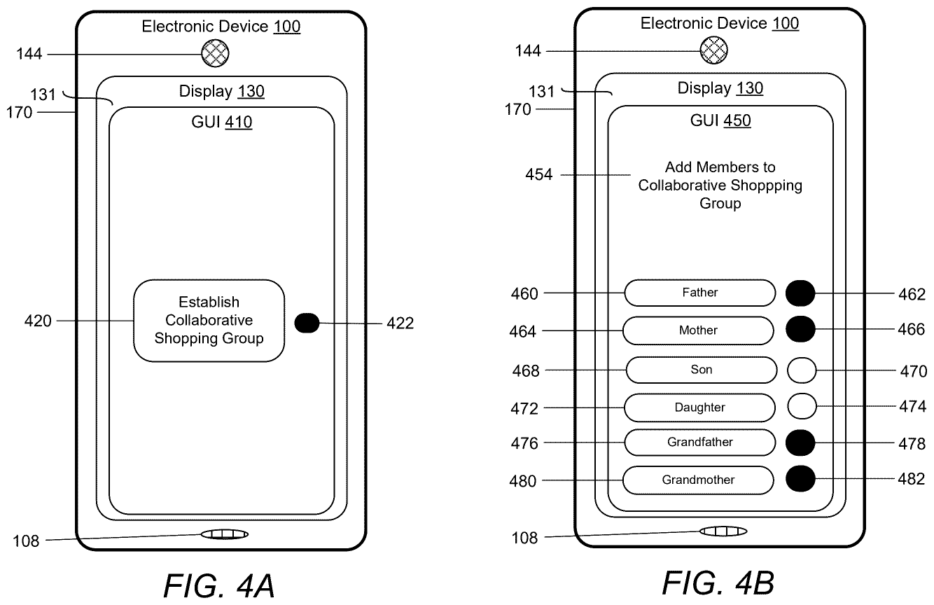

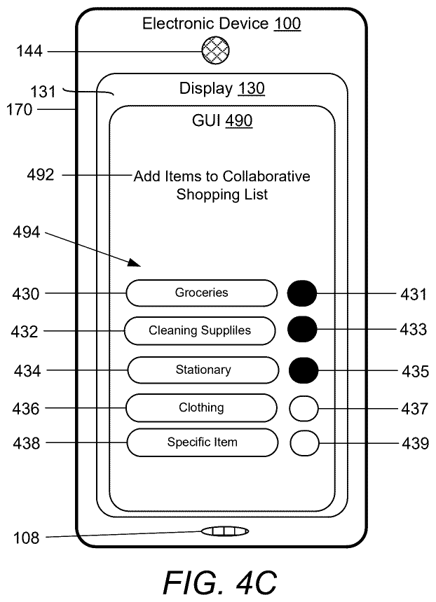

With reference to FIG. 4A, electronic device 100 is shown with an example collaborative shopping group setup (CSGS) graphical user interface (GUI) 410 presented on display 130. CSGS GUI 410 allows a user of electronic device 100 to set-up a collaborative shopping group. CSGS GUI 410 also allows the user to add/edit members, characteristics, list of group items, etc. of the collaborative shopping group. CSGS GUI 410 includes establish collaborative shopping group option 420, with option on/off indication 422. When selected, establish collaborative shopping group option 420 enables electronic device 100 to initiate processes to establish the collaborative shopping group.

With reference to FIG. 4B, electronic device 100 is shown with an example second graphical user interface (GUI) 450 presented on display 130 for adding members to a collaborative shopping group. Collaborative shopping group member update/add (CSGMU) GUI 450 is presented after a user has selected establish collaborative shopping group option 420 of FIG. 4A. CSGMU GUI 450 includes a description 454 of the purpose of GUI 450 and several user selectable options to add family members to a collaborative family shopping group.

Specifically, CSGMU GUI 450 includes several labeled options for each family member with associated on/off indicators that indicate when/whether a specific family member has been added to family shopping group 332 (FIG. 3A). CSGMU GUI 450 includes father selection option 460, with option on/off indication 462. CSGMU GUI 450 also includes mother selection option 464, with option on/off indication 466. CSGMU GUI 450 further includes son selection option 468, with option on/off indication 470, daughter selection option 472, with option on/off indication 474, grandfather selection option 476, with option on/off indication 478, and grandmother selection option 480, with option on/off indication 482. As provided by the example illustration, collaborative family shopping group 332 includes father, mother, grandfather, and grandmother, with respective indications on (darkened or checked). Notably, collaborative family shopping group 332 does not include either of the listed children. It is appreciated that the labels for each of the selectable members can be the actual names of the individuals as taken from the stored contact data 322 or inputted locally by the user within CSGMU GUI 450.

According to one aspect of the disclosure, electronic device 100 can present CSGS GUI 410 on display 130. CSGS GUI 410 includes a user-selectable option 420 to establish a collaborative shopping group. The collaborative shopping group includes one or more individual members whose purchases are tracked within the collaborative shopping data. In response to detecting selection of the user-selectable option 420, electronic device 100 initiates processes to establish the collaborative shopping group.

With reference to FIG. 4C, electronic device 100 is shown with an example collaborative purchase items selection (CPIS) graphical user interface (GUI) 490 presented on display 130 for selecting products or items to be included in a list of collaborative purchased items 494 that are purchased by members of a collaborative shopping group. CPIS GUI 490 includes a description 492 of the purpose of GUI 450 and several user selectable options to add items or categories of items to the list of items to be collaboratively purchased. CPIS GUI 490 includes groceries selection option 430, with option on/off indication 431. CPIS GUI 490 also includes cleaning supplies selection option 432, with option on/off indication 433. CPIS GUI 450 further includes stationary selection option 434, with option on/off indication 435, and clothing selection option 436, with option on/off indication 437. CPIS GUI 450 further includes specific items specific item selection option 438, with option on/off indication 439. As provided by the example illustration of FIG. 4C, list of collaborative purchased items 494 includes groceries, cleaning supplies and stationary. List of collaborative purchased items 494 does not include clothing. Specific item selection option 438 is a user selectable option to add a specific item and quantities of the specific item to the list of collaborative purchased items 494. In one example embodiment, members of a collaborative shopping group may be buying specific items for a party. Specific items added to the list of collaborative purchased items 494 could include items such as cups, paper plates, pizza, bottled water and specific quantities of these items (e.g., 50 cups, 50 paper plates, 3 pizzas, 50 bottles of water).

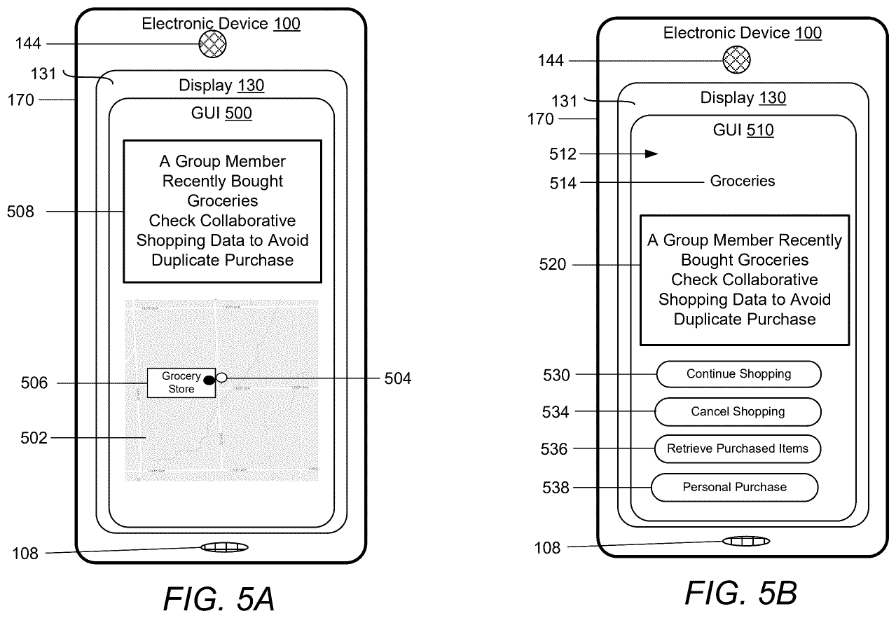

Turning to FIG. 5A, electronic device 100 is shown with an example location-based duplicate purchase alert (LBDPA) graphical user interface (GUI) 500 presented on display 130. LBDPA GUI 500 includes a map 502. Map 502 can show the current location 504 of electronic device 100. Map 502 includes a pre-identified merchant location 506 with the name of the merchant (e.g., grocery store). LBDPA GUI 500 includes a duplicate purchase alert 508. Duplicate purchase alert 508 can indicate that electronic device 100 is at a pre-identified merchant location 506 where the purchase of items may cause a potential duplicate purchase of one or more items.

According to one aspect of the disclosure, electronic device 100 can detect a trigger that is indicative of an intended purchase of a first item. The trigger can be movement of electronic device 100 towards or into a pre-identified merchant location 506, such as a grocery store. To detect the trigger, electronic device 100 monitors, via location sensor 160, for changes in a current location 504 of the electronic device. Electronic device 100 determines, in part via location data received from location sensor 160, if the electronic device has moved to the pre-identified merchant location 506. In response to determining that electronic device 100 has moved to the pre-identified merchant location 506, electronic device 100 initiates processing to determine whether an intended purchase, at the pre-identified merchant location, may cause a potential duplicate purchase that results in presentation of duplicate purchase alert 508. In one embodiment, in response to determining that electronic device 100 has moved to the pre-identified merchant location 506, electronic device 100 can present collaborative shopping data 360 showing items that have already been purchased by other members of the collaborative shopping group. It is appreciated that the above-described location-based trigger can include the AI within the electronic device 100 identifying or determining particular types of merchants that are associated with the items contained in the collaborative list of items. The AI can then monitor the location of the device and periodically compare the current device location 504 to a map 502 that includes an identification of any merchants in proximity to the device. The AI thus identifies whether the electronic device is inside or close to the specific merchant that matches the category/type of merchants that are pre-identified as providing an item from the collaborative list. In an alternate embodiment, the electronic device can present a notification to the user to stop at the particular merchant in proximity to the electronic device in order to purchase a specific item from the list of items that has not yet been purchased.

Referring to FIG. 5B, electronic device 100 is shown with an example shopping application graphical user interface (GUI) 510 presented on display 130. In one embodiment, shopping application GUI 510 can be for an online grocery shopping website. In an embodiment, after shopping application 314 has been initiated, shopping application GUI 510 can be presented with at least one merchandise category to an item that has been previously purchased by a member of a collaborative shopping group. Shopping application GUI 510 includes a shopping page 512 on which is presented a merchandise category 514 that is associated with the shopping application. In FIG. 5B, the merchandise category 514 is “Groceries”.

Shopping application GUI 510 includes a duplicate purchase alert 520 (i.e., a message or notification) that another group member (i.e., another member of family shopping group 332) has recently purchased groceries and the collaborative shopping cart or collaborative shopping data 360 should be checked to avoid a duplicate purchase of the same item. Shopping application GUI 510 further includes selectable continue shopping option 530, cancel shopping option 534, retrieve purchased items option 536, and personal purchase option 538. When selected, continue shopping option 530 enables electronic device 100 to continue using shopping application 314 to purchase groceries. When selected, cancel shopping option 534 enables electronic device 100 to cancel or discontinue shopping application 314. When selected, retrieve purchased items option 536, enables electronic device 100 to retrieve a list of items that have been purchased by group members (i.e., collaborative shopping data 360). When selected, personal purchase option 538, enables electronic device 100 to identify the first intended purchase item 350 as a private purchase that is not be shared to collaborative shopping data 360.

According to one aspect of the disclosure, electronic device 100 can detect a trigger indicative of an intended purchase of a first item 350 (e.g., groceries). In one embodiment, the trigger is initiation of at least one shopping application 314 having a common merchandise category 514 (e.g., groceries) corresponding to a category of items included in a collaborative purchasing group. In response to detecting the trigger, electronic device 100 transmits, to a purchase tracking repository 230 (FIG. 2), a request for collaborative shopping data with at least one previously purchased second item 362. In response to receiving the collaborative shopping data 360 with the at least one previously purchased second item 362, electronic device 100 determines whether the first item 350 (e.g., groceries) is substantially similar to the at least one previously purchased second item 362. In response to the first item 350 being substantially similar to the at least one previously purchased second item, electronic device 100 identifies the intended purchase of the first item as a potential duplicate purchase and presents a duplicate purchase alert 520 on display 130. The duplicate purchase alert indicates that completion of the intended purchase of the first item will potentially result in a duplicate purchase. In another embodiment, electronic device 100 can further identify if the intended purchase of the first item would cause the second item maximum quantity 364G to be exceeded. If the second item maximum quantity 364G is determined to be exceeded, electronic device 100 can present duplicate purchase alert 520 on display 130. Otherwise, the duplicate purchase alert 520 can be modified or replaced with a notification providing the number of such items already purchased and/or remaining to be purchased.

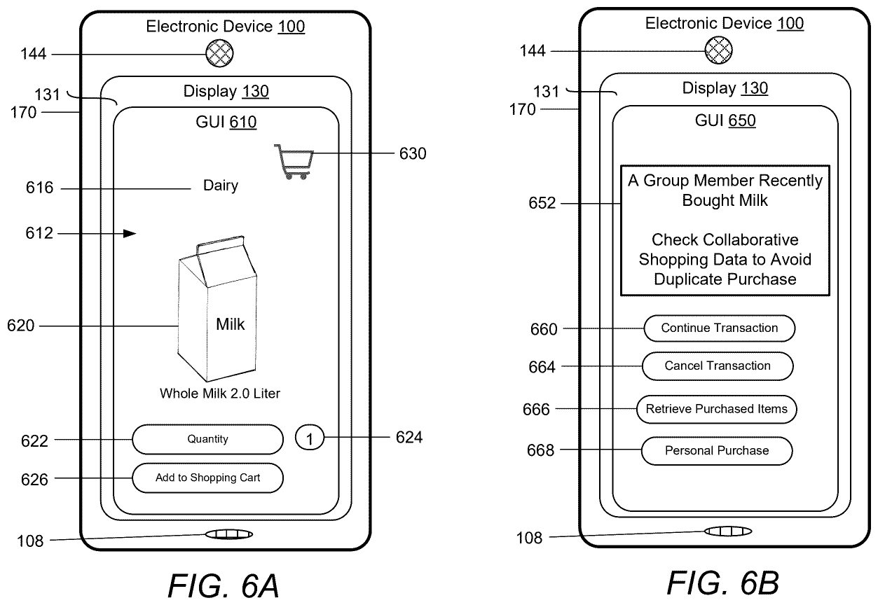

Referring to FIG. 6A, electronic device 100 is shown with an example shopping application graphical user interface (GUI) 610 presented on display 130. In one embodiment, shopping application GUI 610 can be for an online grocery shopping website. In an embodiment, shopping application GUI 610 can be presented after shopping application 314 has been initiated. Shopping application GUI 610 includes a shopping page 612. Shopping application GUI 610 includes a merchandise category 616 and a product or item 620 that can be purchased. In FIG. 6A, the merchandise category 616 that has been selected is “Dairy” and the selected item 620 is a 2.0 liter container of whole milk.

Shopping application GUI 610 further includes quantity option 622, with numerical selection indication 624, and add to shopping cart option 626. Quantity option 622 enables electronic device 100 to receive input, e.g., via touch screen 131, to a numerical selection indication 624 of the number of items 620 that are to be purchased. When selected, add to shopping cart option 626 enables electronic device 100 to add item 620 to shopping cart 630 of shopping application 314.

According to one aspect of the disclosure, electronic device 100 can monitor and track personal items, such as item 620 that have been purchased, via electronic device 100 over a period of time. Electronic device 100 can compile a list of personal purchase items that have been purchased during a time period (e.g., over the last 30 days) and present the list when an intended purchase of an item is detected. Electronic device 100 can track the purchase of personal items and present a duplicate purchase alert (i.e., a message or notification) when the purchase of the same item is detected within a pre-determined period of time to prevent the same user buying the same personal-use items twice in a short period of time.

According to another aspect of the disclosure, electronic device 100 can detect a trigger that is indicative of an intended purchase of an item. The trigger can be electronic device 100 scanning items (e.g., item 620) that are intended to be purchased using one of front or rear cameras 132, 133. In one embodiment, a bar code of item 620 can be scanned to add the item to shopping cart 630 and cause a trigger that is indicative of an intended purchase of an item.

Referring to FIG. 6B, electronic device 100 is shown with an example shopping application graphical user interface (GUI) 650 presented on display 130 after the container of milk (i.e., item 620) has been added to shopping cart 630. Shopping application GUI 650 includes a duplicate purchase alert 652 (i.e., a message or notification) that another group member (i.e., another member of family shopping group 332) has recently purchased milk and the collaborative shopping cart or collaborative shopping data 360 should be checked to avoid a duplicate purchase of the same item. In one embodiment, the addition of item 620 (e.g., milk) to the shopping cart 630 also causes the item 620 to be added to the collaborative shopping data 360. The collaborative shopping data 360 is transmitted to application computer system 180 where the collaborative shopping data is shared with other electronic devices (e.g. second electronic device 184, FIG. 1).

Shopping application GUI 650 further includes continue transaction option 660, cancel transaction option 664, retrieve purchased items option 666, and personal purchase option 668. When selected, continue transaction option 660, enables electronic device 100 to continue the intended transaction to purchase milk (i.e., item 620). When selected, cancel transaction shopping option 664, enables electronic device 100 to discontinue the intended transaction to purchase milk and to remove item 620 from shopping cart 630. When selected, retrieve purchased items option 666 enables electronic device 100 to retrieve a list of items that have been purchased by group members (i.e., collaborative shopping data 360). When selected, personal purchase option 668 enables electronic device 100 to identify the first intended purchase item 350 as a private purchase that is not be shared to collaborative shopping data 360.

According to one aspect of the disclosure, electronic device 100 can detect a trigger indicative of an intended purchase of an item 620 (e.g., milk). In one embodiment, the trigger is the addition of at least one item to shopping cart 630. In response to detecting the trigger, electronic device 100 transmits, to a purchase tracking repository 230, a request for collaborative shopping data with at least one previously purchased second item. In response to receiving the collaborative shopping data 360 with the at least one previously purchased second item 362, electronic device 100 determines whether the item 620 (e.g., milk) is substantially similar to the at least one previously purchased second item 362. In response to the item 620 being substantially similar to the at least one previously purchased second item 362, electronic device 100 identifies the intended purchase of the item 620 as a potential duplicate purchase and presents duplicate purchase alert 652 on display 130. The duplicate purchase alert 652 indicates that completion of the intended purchase of the item 620 will potentially result in a duplicate purchase.

According to another aspect of the disclosure, electronic device 100 can track purchases of items over a period of time, via parsing of collaborative shopping data 360, and identify if an intended purchase would cause a potential duplicate purchase within a pre-established tracking period. In an example embodiment, electronic device 100 can determine that at least one previously purchased second item 362 was purchased via a purchase transaction via a second electronic device 184 at a corresponding second time 364D within a pre-established tracking period 364E (e.g., during the last 30 days) for preventing potential duplicative purchases. Electronic device 100 presents a duplicate purchase alert 652 on display 130 of electronic device 100 if the purchase is occurring within the pre-established tracking period 364E; however, no duplicate purchase alert is presented if the purchase is occurring outside of the pre-established tracking period 364E.

According to an additional aspect of the disclosure, the electronic device 100 determines if the second time 364D is within the pre-established tracking period 364E for preventing potential duplicative purchases. In response to determining the second time 364D is within the pre-established tracking period 364E for preventing potential duplicative purchases, electronic device 100 enables presenting the duplicate purchase alert 652 on the display 130. In response to determining the second time 364D is not within the pre-established tracking period 364E for preventing potential duplicative purchases, withholds presenting the duplicate purchase alert 652 on the display 130.

According to one more aspect of the disclosure, to detect the trigger indicative of an intended purchase of an item, electronic device 100 detects at least one of (i) addition of the first intended purchase item 350 to the collaborative shopping cart 630 or (ii) initiation of at least one shopping application 314 having a common merchandise category with the first intended purchase item 350. Electronic device 100 presents the duplicate purchase alert 652 in response to detecting either (i) addition of the first intended purchase item 350 to the collaborative shopping cart 630 or (ii) initiation of at least one shopping application 314 having a common merchandise category with the first intended purchase item 350.

According to yet another aspect of the disclosure, electronic device 100 can present GUI 650 on display 130. GUI 650 includes a duplicate purchase alert 652 and a first user-selectable option 664 to cancel the intended purchase of the item 620. In response to detecting selection of the first user-selectable option 664, electronic device 100 cancels the intended purchase of the item 620.

According to one more additional aspect of the disclosure, electronic device 100 can present GUI 650 on display 130. GUI 650 includes a duplicate purchase alert 652 and a second user-selectable option 660 to continue the intended purchase of the item 620. In response to detecting selection of the second user-selectable option 660, electronic device 100 triggers completion of the intended purchase of the item 620, updates the collaborative shopping data 360 with the completed purchase data of item 620 and stores the updated collaborative shopping data.

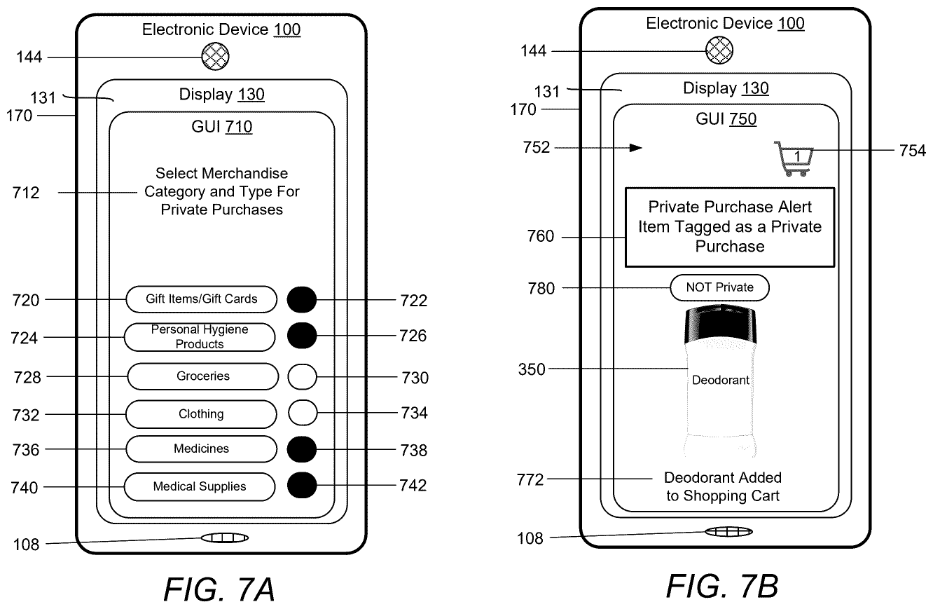

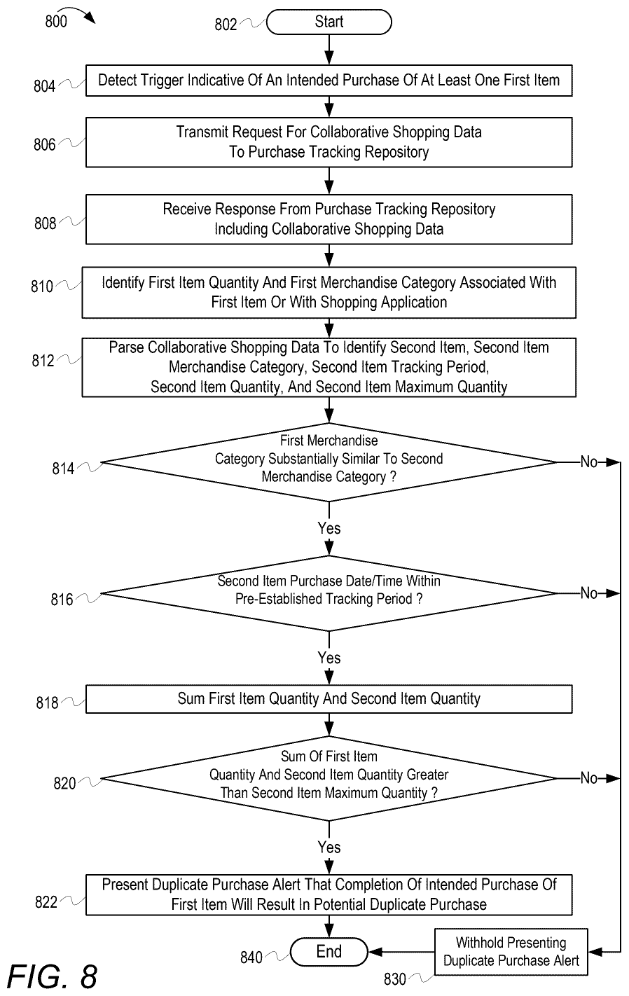

According to one more aspect of the disclosure, electronic device 100 can present GUI 650 on display 130. GUI 650 includes a duplicate purchase alert 652 and a user-selectable option 668 to identify the purchase of item 620 as a personal purchase that is not be shared to collaborative shopping data 360. In response to detecting selection of the user-selectable option 668, electronic device 100 withholds transmitting notification of the intended purchase of the item 620 to collaborative shopping database 232. Turning to FIG. 7A, electronic device 100 is shown with an example graphical user interface (GUI) 710 presented on display 130 for enabling the user to select merchandise categories and types for private purchases. Private purchases setup (PPS) GUI 710 enables a user to select one or more merchandise categories and types to be designated as private purchase transactions for which notification of items selected as intended purchases are prevented from being transmitted to collaborative shopping database 232. PPS GUI 710 includes a description 712 of GUI 710 and several user selectable options to select merchandise categories and types as confidential or private purchases. PPS GUI 710 also includes several selectable options to add specific types of items corresponding to a particular merchandise category and/or type to private purchase data 380. Each selectable option has an associated on/off indication that toggles on when the listed item/category is selected.

PPS GUI 710 includes gift items/gift cards option 720, with option on/off indication 722, personal hygiene products option 724, with option on/off indication 726, and groceries option 728, with option on/off indication 730, clothing option 732, with option on/off indication 734, medicine option 736, with option on/off indication 738, and medical products option 740, with option on/off indication 742. In FIG. 7A, gift items/gift cards option 720, personal hygiene products option 724, medicine option 736, and medical products option 740 have been selected as merchandise categories and types for private purchase data 380 with respective option on/off indications 722, 726, 738, and 742 filled in or checked.

According to one aspect of the disclosure, electronic device 100 can present PPS GUI 710 on display 130. PPS GUI 710 includes a first user-selectable option (e.g., option 720) to select at least one merchandise category and type for inclusion with the private purchase data 380. In response to detecting selection of the first user-selectable option (e.g., option 720), electronic device 100 initiates processes to select the at least one merchandise category and type for inclusion with the private purchase data 380. Electronic device 100 accesses the private purchase data 380 with the at least one merchandise category and type during a subsequent purchase transaction to determine whether an item being purchased via the subsequent purchase transaction is a private purchase.

With reference FIG. 7B, electronic device 100 is shown with an example private purchase notification or alert (PPN) graphical user interface (GUI) 750 presented on display 130. PPN GUI 750 includes a shopping page 752. In FIG. 7B, PPN GUI 750 is shown after an item (e.g., first intended purchase item 350) has been selected for purchase and added to shopping cart 754. In FIG. 7B, the first intended purchase item 350 is deodorant. PPN GUI 750 includes a message 772 that the first intended purchase item 350 has been added to shopping cart 754. PPN GUI 750 includes a private purchase alert 760 (i.e., a message or notification) that the purchase transaction involving the first intended purchase item 350 has been tagged as a confidential purchase transaction that is not to be shared to collaborative shopping database 232. PPN GUI 750 further includes a user selectable option 780 to mark or tag the first intended purchase item 350 as not being a private purchase. In response to detecting selection of user-selectable option 780, electronic device 100 tags the first intended purchase item 350 as a purchase transaction that is not private and transmits notification of the intended purchase of the first intended purchase item 350 to collaborative shopping database 232.

According to one aspect of the disclosure, electronic device 100 can detect a trigger indicative of an intended purchase of a first intended purchase item 350. In an embodiment, the trigger can be adding the item to a shopping cart of a shopping application. In response to detecting the trigger, electronic device 100 identifies a first merchandise category and type (e.g., intended purchase item merchandise category and type 352) associated with the first intended purchase item 350. Electronic device 100 determines if the first merchandise category and type (e.g., intended purchase item merchandise category and type 352) corresponds to a purchase transaction that is to be maintained as a private purchase transaction. In response to determining that the first merchandise category and type is one that is pre-established as a private purchase transaction, electronic device 100 withholds transmitting notification of the intended purchase of the first intended purchase item 350 to collaborative shopping database 232.

According to one more aspect of the disclosure, electronic device 100 can detect the selection of user selectable not private option 780. In response to detecting selection of user-selectable option 780, electronic device 100 tags the first intended purchase item 350 as a purchase transaction that is not private and transmits notification of the intended purchase of the first intended purchase item 350 to collaborative shopping database 232.

According to another aspect of the disclosure, in response to determining that the first merchandise category and type 352 is not a private purchase transaction: electronic device 100 determines whether the first intended purchase item 350 matches one or more items to be purchased as a collaborative purchase. Electronic device 100 transmits a notification of the intended purchase of the first intended purchase item 350 to the collaborative shopping database 232 in response to the first item matching at least one item to be purchased as a collaborative purchase.

According to one more aspect of the disclosure, to detect the trigger, electronic device 100 detects at least one of (i) addition of the first intended purchase item 350 to a shopping cart 630 or (ii) initiation of at least one shopping application 314 associated with a first merchandise category and type in common with the at least one merchandise category and type 382 of the private purchase data 380.

According to an additional aspect of the disclosure, electronic device 100 can present private purchase alert GUI 750 on display 130. GUI 750 includes a private purchase alert 760 (i.e., a message or notification) that the purchase transaction involving the first intended purchase item 350 has been tagged as a confidential purchase transaction.

FIG. 8 depicts method 800 by which electronic device 100 tracks personal and collaborative purchasing to identify and generate a notification about a potential duplicate purchase of at least one item. FIG. 9 depicts method 900 by which electronic device 100 monitors and identifies if an incoming communication contains information corresponding to the purchase of at least one item and in response the incoming communication containing information corresponding to the purchase of the at least one item, updates a collaborative shopping database with the purchase of the at least one item. FIG. 10 depicts method 1000 by which electronic device 100 tracks personal and collaborative purchasing of at least one item to identify if an item that is being purchased is a private purchase transaction that should not be made public or known to others in a collaborative shopping group.

The description of methods 800, 900 and 1000 will be described with reference to the components and examples of FIGS. 1-7B. The operations depicted in FIGS. 8-10 can be performed by electronic device 100 or any suitable electronic device that includes the one or more functional components of electronic device 100 that provide/enable the described features. One or more of the processes of the methods described in FIGS. 8 and 9 may be performed by processor 102 executing program code associated with duplicate purchase alert module 128. One or more of the processes of the method described in FIG. 10 may be performed by processor 102 executing program code associated with purchase tracking and alert module 127.

With specific reference to FIG. 8 method 800 begins at the start block 802. At block 804, method 800 includes detecting a trigger that is indicative of the intended purchase of at least one first item (e.g., first intended purchase item 350). In one embodiment, the trigger can be the initiation of at least one shopping application 314 or the addition of at least one item to a shopping cart 630. Method 800 includes transmitting a request 260 for collaborative shopping data 234 to purchase tracking repository 230 (block 806) and receiving a response 262 from purchase tracking repository 230 including the collaborative shopping data 234 (block 808). The received collaborative shopping data 234 is stored as collaborative shopping data 360 to system memory 120.

Method 800 includes identifying a first intended purchase item quantity (e.g., first intended purchase item quantity 354) and merchandise category (e.g., first intended purchase item merchandise category and type 352) associated with the first intended purchase item 350 or with shopping application 314 (block 810). Method 800 includes parsing the received collaborative shopping data 360 to identify a second previously purchased second item 362, and one or more of second item merchandise category 364A, second item quantity 364C, second item date/time purchased 364D, second item tracking period 364E, and second item maximum quantity 364G (block 812).

Method 800 includes determining if the first intended purchase item merchandise category and type 352 is substantially similar to second item merchandise category 364A (decision block 814). In response to determining that the merchandise category and type 352 of the first intended purchase item is not substantially similar to second item merchandise category 364A, method 800 includes withholding presentation of a duplicate purchase alert 520, 652 on the display (block 830). Method 800 ends at end block 840. In response to determining that the first intended purchase item merchandise category and type 352 is substantially similar to second item merchandise category 364A, method 800 includes determining if the second item date/time purchased 364D is within the second item tracking period 364E (decision block 816).

In response to determining that the second item date/time purchased 364D is not within the second item tracking period 364E, method 800 includes withholding presentation of a duplicate purchase alert 520, 652 on the display (block 830). Method 800 ends at end block 840. In response to determining that the second item date/time purchased 364D is within the second item tracking period 364E, method 800 includes summing the first intended purchase item quantity 354 and the second item quantity 364C (block 818). Method 800 includes determining if the sum of the first intended purchase item quantity 354 and the second item quantity 364C is greater than the second item maximum quantity 364G (decision block 820). In one embodiment, for some items/products, more than one item (i.e., multiple items) may be required for purchase by the members of the collaborative shopping group. For example, if the item is soda, perhaps twenty bottles of soda are required by the members of the collaborative shopping group.

In response to determining that the sum of the first intended purchase item quantity 354 and the second item quantity 364C is not greater than the second item maximum quantity 364G, method 800 includes withholding presentation of a duplicate purchase alert 520, 652 on the display (block 830). Method 800 ends at end block 840. In response to determining that the sum of the first intended purchase item quantity 354 and the second item quantity 364C is greater than the second item maximum quantity 364G, method 800 includes presentation of duplicate purchase alert 520, 652 on display 130 (block 822). Additionally or alternatively, method 800 can include surfacing an indication that a duplicate purchase is recorded with the total number of the items previously purchased and the maximum number/amount of the items required (i.e., second item maximum quantity 364G). This information can then be used to guide the user in the purchase of the items so as not to exceed the maximum required number/amount. In one embodiment, electronic device 100 can monitor and track personal items, such as item 620 that have been purchased, via electronic device 100 over a period of time. Electronic device 100 can track the purchase of personal items and present a duplicate purchase alert 652 (i.e., a message or notification) when the purchase of the same item is detected within a pre-determined period of time (e.g., second item tracking period 364E) to prevent the same user buying the same personal-use items twice in a short period of time. Method 800 terminates at end block 840.

FIG. 9 depicts method 900 by which electronic device 100 updates a collaborative shopping database in response to identifying that an incoming communication contains information corresponding to the purchase of at least one item. With specific reference to FIG. 9, method 900 begins at the start block 902. Method 900 includes monitoring for receipt of incoming communications 264 from an application computer system 180 or an online shopping server 182 (block 904). Method 900 includes determining if an incoming communications 264 has been received (decision block 906). In response to determining that an incoming communications 264 has not been received, method 900 returns to block 904 to continue monitoring for receipt of incoming communications 264.

In response to determining that an incoming communications 264 has been received, method 900 includes identifying that that the incoming communication contains at least one information 344 corresponding to purchasing of an item 346 (block 908). In response to identifying that the incoming communication 264 contains at least one information 344 corresponding to purchasing of the item 346, method 900 includes identifying a merchandise category 347 associated with the item 346 based on the at least one information 344 (block 910).

Method 900 includes transmitting a request 260 for collaborative shopping data 234 to purchase tracking repository 230 (block 912) and receiving a response 262 from purchase tracking repository 230 including the collaborative shopping data 234 (block 914). Method 900 includes updating the collaborative shopping data with the purchase of the item 346, the merchandise category 347 associated with the item, and the date and time 348 the item was purchased (block 916). Method 900 includes storing the updated collaborative shopping data 360 to system memory 120 (block 918) and transmitting the updated collaborative shopping data 360 to purchase tracking repository 230 (block 920). Method 900 terminates at end block 940.

FIG. 10 depicts method 1000 by which electronic device 100 tracks personal and collaborative purchasing of at least one item to identify if an item that is being purchased is a private purchase transaction. With specific reference to FIG. 10, method 1000 begins at the start block 1002. At block 1004, method 1000 includes detecting a trigger that is indicative of the intended purchase of at least one first item (e.g., first intended purchase item 350). In one embodiment, the trigger can be the initiation of at least one shopping application 314 or the addition of at least one item to a shopping cart 630.

Method 1000 includes identifying a merchandise category and type (e.g., first intended purchase item merchandise category and type 352) associated with the first intended purchase item 350 (block 1006). Method 1000 includes retrieving private purchase data 380 from system memory 120 (block 1008). Method 1000 includes determining if the first intended purchase item merchandise category and type 352 is substantially similar to at least one of private merchandise categories and types 382 of private purchase data 380 (decision block 1010).

In response to determining that the first intended purchase item merchandise category and type 352 is substantially similar to at least one of private merchandise categories and types 382 of private purchase data 380, method 1000 includes tagging the purchase transaction involving the first intended purchase item 350 as a confidential purchase transaction that is not to be shared with others within collaborative shopping group 330 (block 1012). Method 1000 includes withholding transmission of a notification of the intended purchase of the first item 350 to collaborative shopping database 232 (block 1014). Method 1000 includes presenting a private purchase alert 760 on display 130 that the purchase transaction involving the first item 350 has been tagged as a confidential purchase transaction (block 1016).

Method 1000 includes determining if a user selectable option 780 to mark or tag the first item 350 as not being a private purchase has been selected (decision block 1017). In response to determining that the user selectable option 780 has not been selected, method 1000 terminates at end block 1040. In response to determining that the user selectable option 780 has been selected, method 1000 includes evaluating the item as a collaborative shopping item for possible notification of a duplicate purchase alert (block 1018).

Returning to decision block 1010, in response to determining that the first intended purchase item merchandise category and type 352 is not substantially similar to at least one of private merchandise categories and types 382 of private purchase data 380, and after block 1018, method 1000 includes transmitting a request 260 for collaborative shopping data 234 to purchase tracking repository 230 (block 1019) and receiving a response 262 from purchase tracking repository 230 including the collaborative shopping data 234 (block 1020). According to one embodiment, merchandise category and type 352 is used in place of, or in addition to, the specific identification of the product or item since a generic version of the product or item may not look like the product identified as private, which could lead to faulty or missed classifications of private versus collaborative purchases.

Method 1000 includes determining whether the first intended purchase item merchandise category and type 352 substantially matches at least one merchandise category and type of collaborative shopping data 234 (decision block 1022). According to one aspect of the disclosure, method 1000 determines whether the first item 350 matches one or more items to be purchased as a collaborative purchase. In response to determining that the first intended purchase item merchandise category and type 352 does not substantially match at least one merchandise category and type of collaborative shopping data 234, method 1000 ends at end block 1040.

In response to determining that the first intended purchase item merchandise category and type 352 substantially matches at least one merchandise category and type of collaborative shopping data 234, method 1000 transmits a notification of the intended purchase of the first item 350 to the collaborative shopping database 234 (block 1024). Method 1000 terminates at end block 1040.

In the above-described methods of FIGS. 8-10, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals; but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a display;
a communication system that enables the electronic device to connect to external networks and devices;
a memory having stored thereon a duplicate purchase alert (DPA) module for tracking personal and collaborative purchasing to identify and generate notification about a potential duplicate purchase of at least one item; and
at least one processor communicatively coupled to the display, the communication system, and the memory, the at least one processor executing program code of the duplicate purchase alert module, which configures the electronic device to:
detect a trigger indicative of an intended purchase of a first item;
in response to detecting the trigger, transmit, to a purchase tracking repository, a request for collaborative shopping data with at least one previously purchased second item;
in response to receiving the collaborative shopping data with the at least one previously purchased second item, determine whether the first item is substantially similar to the at least one previously purchased second item; and
in response to the first item being substantially similar to the at least one previously purchased second item:
identify the intended purchase of the first item as a potential duplicate purchase; and
present a duplicate purchase alert on the display, the duplicate purchase alert indicating that completion of the intended purchase of the first item will potentially result in a duplicate purchase.

2. The electronic device of claim 1, wherein the at least one previously purchased second item was purchased via a purchase transaction via a second electronic device at a corresponding second time within a pre-established tracking period for preventing potential duplicative purchases.

3. The electronic device of claim 2, wherein the at least one processor:
determines if the second time is within the pre-established tracking period for preventing potential duplicative purchases;
in response to determining the second time is within the pre-established tracking period for preventing potential duplicative purchases, enables presenting the duplicate purchase alert on the display; and
in response to determining the second time is not within the pre-established tracking period for preventing potential duplicative purchases, withholds presenting the duplicate purchase alert on the display.

4. The electronic device of claim 1, wherein to detect the trigger, the at least one processor:
determines if at least one shopping application has been initiated on the electronic device;
in response to determining that at least one shopping application has been initiated on the electronic device, identifies a first merchandise category associated with the at least one shopping application;
retrieves, from the collaborative shopping data, a second merchandise category associated with the at least one previously purchased second item;
determines if the second merchandise category is substantially similar to the first merchandise category; and
identifies the potential duplicate purchase in response to determining that the second merchandise category is substantially similar to the first merchandise category.

5. The electronic device of claim 1, wherein to detect the trigger, the at least one processor:
detects at least one of (i) addition of the first item to a collaborative shopping cart or (ii) initiation of at least one shopping application having a common merchandise category with the first item; and
presents the duplicate purchase alert in response to detecting either (i) addition of the first item to a collaborative shopping cart or (ii) initiation of at least one shopping application having a common merchandise category with the first item.

6. The electronic device of claim 1, wherein the at least one processor:
monitors for receipt of incoming communications;
identifies that an incoming communication contains at least one information corresponding to purchasing of a third item; and
in response to identifying that the incoming communication contains at least one information corresponding to purchasing of the third item:
identifies a third merchandise category associated with the third item based on the at least one information;
updates the collaborative shopping data with the purchase of the third item, the third merchandise category associated with the third item, and a date and time that the third item was purchased; and
stores the updated collaborative shopping data.

7. The electronic device of claim 1, wherein the at least one processor:
presents a first graphical user interface (GUI) on the display, the first GUI including the duplicate purchase alert and a first user-selectable option to cancel the intended purchase of the first item; and
in response to detecting selection of the first user-selectable option, cancels the intended purchase of the first item.

8. The electronic device of claim 1, wherein the at least one processor:
presents a first graphical user interface (GUI) on the display, the first GUI including the duplicate purchase alert and a second user-selectable option to continue the intended purchase of the first item; and
in response to detecting selection of the second user-selectable option:
triggers completion of the intended purchase of the first item;
updates the collaborative shopping data with completed purchase data of the first item; and
stores the updated collaborative shopping data.

9. The electronic device of claim 1, wherein the at least one processor:
presents a third graphical user interface (GUI) on the display, the third GUI including a third user-selectable option to establish a collaborative shopping group, the collaborative shopping group including one or more individual members whose purchases are tracked within the collaborative shopping data; and
in response to detecting selection of the third user-selectable option, initiates processes to establish the collaborate shopping group.

10. A method comprising:
detecting, via at least one processor of an electronic device, a trigger indicative of an intended purchase of a first item;
in response to detecting the trigger, transmitting, to a purchase tracking repository, a request for collaborative shopping data with at least one previously purchased second item;
in response to receiving the collaborative shopping data with the at least one previously purchased second item, determining whether the first item is substantially similar to the at least one previously purchased second item; and
in response to the first item being substantially similar to the at least one previously purchased second item:
identifying the intended purchase of the first item as a potential duplicate purchase; and
presenting a duplicate purchase alert on a display, the duplicate purchase alert indicating that completion of the intended purchase of the first item will potentially result in a duplicate purchase.

11. The method of claim 10, wherein the at least one previously purchased second item was purchased via a purchase transaction via a second electronic device at a corresponding second time within a pre-established tracking period for preventing potential duplicative purchases.

12. The method of claim 11, further comprising:
determining if the second time is within the pre-established tracking period for preventing potential duplicative purchases;
in response to determining the second time is within the pre-established tracking period for preventing potential duplicative purchases, enabling the presentation of the duplicate purchase alert on the display; and
in response to determining the second time is not within the pre-established tracking period for preventing potential duplicative purchases, withholding the presentation of the duplicate purchase alert on the display.

13. The method of claim 10, wherein to detect the trigger, the method further comprises:
determining if at least one shopping application has been initiated on the electronic device;
in response to determining that at least one shopping application has been initiated on the electronic device, identifying a first merchandise category associated with the at least one shopping application;
retrieving, from the collaborative shopping data, a second merchandise category associated with the at least one previously purchased second item;
determining if the second merchandise category is substantially similar to the first merchandise category; and
identifying the potential duplicate purchase in response to determining that the second merchandise category is substantially similar to the first merchandise category.

14. The method of claim 10, wherein to detect the trigger, the method further comprises:
detecting at least one of (i) addition of the first item to a collaborative shopping cart or (ii) initiation of at least one shopping application having a common merchandise category with the first item; and
presenting the duplicate purchase alert in response to detecting either (i) addition of the first item to a collaborative shopping cart or (ii) initiation of at least one shopping application having a common merchandise category with the first item.

15. The method of claim 10, further comprising:
monitoring for receipt of incoming communications;
identifying that an incoming communication contains at least one information corresponding to purchasing of a third item; and
in response to identifying that the incoming communication contains at least one information corresponding to purchasing of the third item:
identifying a third merchandise category associated with the third item based on the at least one information;
updating the collaborative shopping data with the purchase of the third item, the third merchandise category associated with the third item, and a date and time that the third item was purchased; and
storing the updated collaborative shopping data.

16. The method of claim 10, further comprising:
presenting a first graphical user interface (GUI) on the display, the first GUI including the duplicate purchase alert and a first user-selectable option to cancel the intended purchase of the first item; and
in response to detecting selection of the first user-selectable option, canceling the intended purchase of the first item.

17. The method of claim 10, further comprising:
presenting a first graphical user interface (GUI) on the display, the first GUI including the duplicate purchase alert and a second user-selectable option to continue the intended purchase of the first item; and
in response to detecting selection of the second user-selectable option:
triggering completion of the intended purchase of the first item;
updating the collaborative shopping data with completed purchase data of the first item; and
storing the updated collaborative shopping data.

18. The method of claim 10, further comprising:
presenting a third graphical user interface (GUI) on the display, the third GUI including a third user-selectable option to establish a collaborative shopping group, the collaborative shopping group including one or more individual members whose purchases are tracked within the collaborative shopping data; and
in response to detecting selection of the third user-selectable option, initiating processes to establish the collaborate shopping group.

19. A computer program product comprising:
a computer readable storage device having stored thereon program code which, when executed by at least one processor of an electronic device having a display, a communication system, and a memory, enables the electronic device to complete the functionality of:
detecting a trigger indicative of an intended purchase of a first item;
in response to detecting the trigger, transmitting, to a purchase tracking repository, a request for collaborative shopping data with at least one previously purchased second item;
in response to receiving the collaborative shopping data with the at least one previously purchased second item, determining whether the first item is substantially similar to the at least one previously purchased second item; and
in response to the first item being substantially similar to the at least one previously purchased second item:
identifying the intended purchase of the first item as a potential duplicate purchase; and
presenting a duplicate purchase alert on a display, the duplicate purchase alert indicating that completion of the intended purchase of the first item will potentially result in a duplicate purchase.

20. The computer program product of claim 19, wherein the at least one previously purchased second item was purchased via a purchase transaction via a second electronic device at a corresponding second time within a pre-established tracking period for preventing potential duplicative purchases.
